(19) United States
(12) Patent Application Publication
(10) Pub. No.: US 2004/0076007 A1
(43) Pub. Date: Apr. 22, 2004

(54) Decorative wall hanging

(76) Inventor: Koichi Hamazaki, Bedminster, NJ (US)

Correspondence Address: BRIAN M BERLINER, ESQ, O'MELVENY & MYERS, LLP, 400 SOUTH HOPE STREET, LOS ANGELES, CA, 90071-2899, US

(21) Appl. No.: 10/278,489

(22) Filed: Oct. 22, 2002

(51) Int. Cl. F21V 21/00

(52) U.S. Cl. 362/249; 362/806

(57) ABSTRACT

A decorative wall hanging is made up of a substantially flat pliable matrix comprised of intertwined cords, such as a macrame or knitted matrix. The pliable matrix defines a pattern of regularly spaced openings, with each opening defined by adjacent ones of the cords. The matrix has a front side and a back side, and defines an outline of a decorative shape. The wall hanging may include a plurality of miniature lights interconnected by a wire, with each of the miniature lights inserted through one of the openings so as to be visible from the front side of the matrix with the wire running along the back side of the matrix. The wall hanging may also include a rigid bar removably attached to the back side of the matrix, to maintain the wall hanging in the desired shape. In an embodiment of the invention, the decorative effect of the wall hanging is that of a lighted Christmas tree.

### BACKGROUND OF THE INVENTION

1. Field of the Invention

The present invention relates to decorative wall hangings, and more particularly to wall hangings with integrated openings, such as macrame wall hangings and the like.

2. Description of Related Art

Macramé has long been known as a coarse lacework made by weaving and knotting cords into a pattern. In American folk art, macramé has been used to fashion various types of folk art for display in the home, often using colorful yarns in patterns reflecting themes of home and family. In particular, macrame has been used to make holiday decorations for the home, including decorations intended to be vertically hung from walls, doors, over windows, or the like. Decorations of this type, whether or not for use during holidays or made by a macrame process, are generally referred to herein as “wall hangings.”

In today's world, however, fewer people are willing to spend the time necessary to create their own works of macrame or similar art than would be willing to display tasteful and creative decorative wall hangings in their homes, especially during holiday seasons. It is desirable therefore to provide suitable finished wall hangings as a commercial product for the home, especially around holiday times. It may also be desirable to provide macramé wall hangings, or wall hangings that resemble macramé wall hangings.

One of the drawbacks of macramé when used in wall hangings is its tendency to become misshapen under its own weight, because of its soft, pliable nature. This problem becomes worse as the macramé piece becomes larger. It is traditional, therefore, for macramé wall hangings to be knotted onto an internal frame that maintains the intended shape of the wall hanging for display. However, the presence of an internal frame can make the macramé product bulkier than is optimal for shipping purposes, as well as increasing manufacturing costs by complicating the required knotting. And in general, traditional macramé arts may lack features that would make them more appealing to modern consumers for specific applications. It is desirable, therefore, to overcome these limitations with an improved wall hanging, such as a macramé wall hanging, that can find a place in many modern homes at inexpensive prices.

### SUMMARY OF THE INVENTION

The present invention provides a large decorative wall hanging that overcomes the limitations of prior art macramé wall hangings, and the like. Wall hangings according to the invention do not require an internal frame, and yet may be hung in a vertical orientation while maintaining their shape. In addition, in an embodiment of the invention, a wall hanging according to the invention is adorned with an array of miniature lights. The miniature lights may be embedded directly into the pliable matrix of the wall hanging, and create a pleasing interplay of light and shadow on adjacent vertical surfaces.

In an embodiment of the invention, a wall hanging is created in the shape of an isosceles triangle with its apex as the highest vertical point and point of attachment for hanging, using any suitable macramé, knitting, or weaving method. This shape forms a widely recognized symbolic representation of a Christmas tree. A regular knotted, knitted, or woven pattern is used, that results in regularly spaced openings. The shape and pattern of the matrix may be selected to achieve lower production costs. In particular, it may be easier to produce a shape with fewer or no internal frame members. External frame members, if desired, may be added later by attaching to the knotted, knitted, or woven matrix using hooks, stitches, staples, or the like. The macramé, knitted, or woven matrix is constructed sufficiently loosely so that miniature lights may be inserted through the interstices of the matrix, and sufficiently tightly so that the lights may be held in place with few or no additional fasteners. An array of lights is inserted from the backside of the hanging in a regular array, so that the lights are visible from its front. The shape of the hanging is maintained by one or more bars that are attached to the rear of the hanging by hooks or other fasteners. The wall hanging with its embedded lights may be rolled into a compact roll for convenient shipping and storage.

When hung on a wall, the visual effect created is impressive enough that some may consider the wall hanging as a replacement for bulkier and more costly decorations, such as Christmas trees. The Christmas-tree effect may be enhanced by the user, if desired, by hanging ornaments from the macramé matrix using hooks, or the like. Of course, the Christmas tree hanging represents only one embodiment of the invention, and similar decorative wall hangings may be made in any desired shape or pattern. Similarly, wall hangings with embedded lights and reinforcement bars may also be made using a knitted fabric as the base matrix, or some other elastic material with regularly spaced holes for lights, such as netting, instead of macramé.

A more complete understanding of the decorative wall hanging will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a plan view showing the front side of an exemplary wall hanging according to the invention.

FIG. 2 is a plan view showing the back side of an exemplary wall hanging according to the invention.

FIG. 3 is an detail view showing the front side of the matrix with an inserted light.

FIG. 4 is a detail side view showing the matrix with an inserted light.

FIG. 5 is an detail view similar to FIG. 3, showing the front side of the matrix with an inserted light according to an alternative embodiment.

### DETAILED DESCRIPTION OF THE PREFERRED EMBODIMENT

The present invention provides a decorative wall hanging, that overcomes the limitations of prior-art wall hangings. In the detailed description that follows, like element numerals are used to indicate like elements appearing in one or more of the figures.

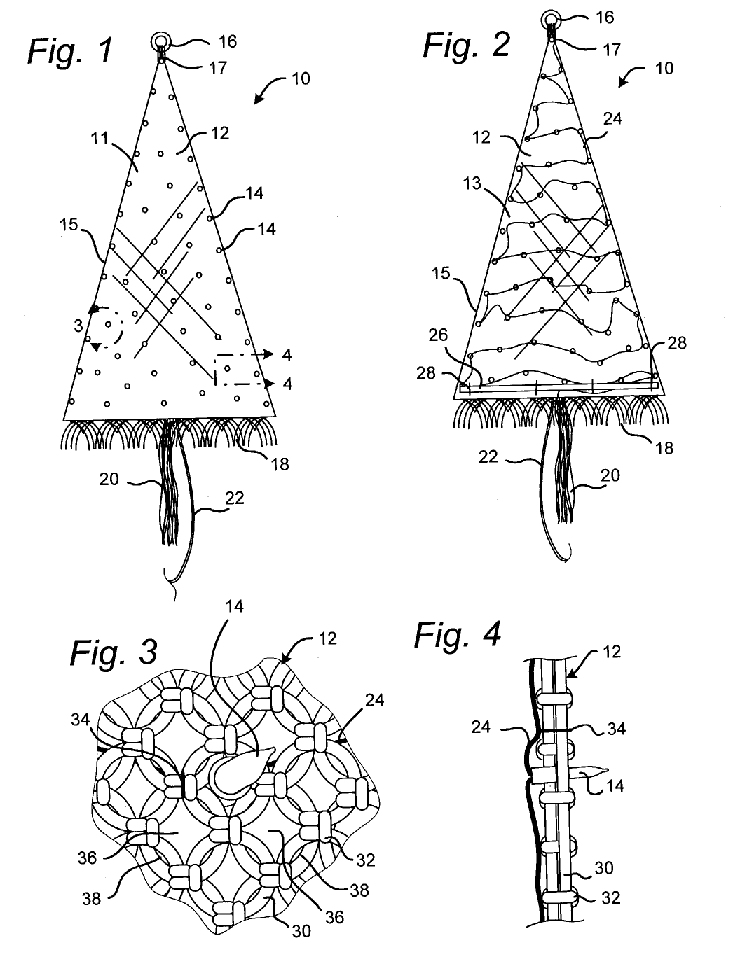

FIGS. 1 and 2 show the front side 11 and back side 13, respectively, of an exemplary wall hanging 10 according to the invention. FIGS. 3 and 4 show front and side detail views, respectively. Referring to FIGS. 1-4, wall hanging 10 comprises a substantially flat pliable matrix 12 comprised of intertwined cords 30 (shown in FIGS. 3 and 4). Cords 30 may be fibrous cords such as yarn, string, twine, etc., monofilament cords, or some combination of the foregoing. Cords 30 define a pattern of regularly spaced openings 36, 38 (shown in FIG. 3), which may include openings of different sizes, such as larger openings 36 and smaller openings 38. Preferably, there are a sufficient number of relatively large openings such that the matrix 10 can transmit appreciable light between its front and back sides. In other words, a tightly woven, opaque fabric matrix is not preferred, although of course there should be a sufficient number of cords to define a decorative and colorful shape. For example, a substantial area of matrix 12 may be comprised of openings that are large enough to receive the base or bulb of a miniature light. A somewhat elastic opening a few millimeters in diameter may be suitable. Larger or smaller openings may also be suitable, depending on the manufacturing method and intended visual effect.

Openings 36 and 38 may be defined by interstices between adjacent cords of matrix 12. Further openings, for example, such as might be made by cutting or punching holes in a fabric material, are neither necessary nor desirable. The invention thereby facilitates the insertion of a string of electric lamps, without need for forming holes apart from those inherent in the matrix itself. In addition, or in the alternative (but less preferably) holes may be made in the matrix after it is formed, to permit the passage of light, and/or for the purpose of holding lamps.

A suitable matrix 10 may be formed by knotting in a macramé fashion, by knitting, or by any other suitable method. Methods of macramé knotting and knitting are well known in the art. In particular, macramé permits decorative patterns of knots separated by regular openings, although macramé materials are somewhat more difficult to mass produce as compared to knitted or woven materials.

Pliable matrix 12 defines an outline 15 of a decorative shape. It should be apparent that outline 15 may include slight irregularities or waviness inherent in the edges of the pliable matrix, depending on its mode of manufacture, and the perfectly straight lines of outline 15 represent a simplification for illustrative purposes. Nevertheless, outline 15 clearly manifests a decorative shape, which in the exemplary embodiment is an isosceles triangle suspended from apex 17, resembling a Christmas tree. A ring 16 may be attached at the apex for hanging the pliable matrix 12 from a hook or other hanger in a vertical surface. A fringe 18 of loose cords may be disposed along a lower edge of the pliable matrix, for decorative effect. A bundle of cords 20 may extend from a central region of the lower edge, enhancing the suggestion of a tree.

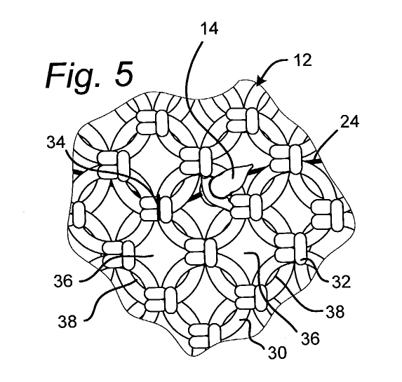

Wall hanging 10 may include a plurality of miniature lights 14 interconnected by a wire 24. Each of the lights 14 is inserted through one of the regular openings 36, 38, for example, through one of the larger openings 36, as shown in FIG. 3. In the alternative, such as shown in FIG. 5, a smaller opening, such as one of openings 38, may be used to more securely hold each light in place. In addition, or in the alternative, a clip 34 or other suitable fastener may be used to secure individual lights or their connecting wire 24 to matrix 12. Miniature lights 14 may comprise any suitable electric lamp, for example, stringed 0.42 or 0.75 Watt lamps such as are commonly available for holiday or garden lighting. In the alternative, light-emitting diodes (LED's) may be used. When wall hanging 10 is hung adjacent to a vertical surface and lighted, interplay between the lights and the pattern of openings in the pliable matrix 10 may create pleasing patterns of light and shadow that enhance the wall hanging's overall decorative effect.

A suitable string of lamps may include an unlighted extension portion 22 for connecting to a wall socket. The extension portion 22 may be hidden from view in or behind bundle 20.

Prior-art macramé wall hangings sometimes incorporated an internal framework for maintaining the shape of the pliable matrix. Incorporating the framework made the required knotting more complex, resulting in higher production costs. The present invention overcomes this limitation by producing the pliable matrix 12 without an integrated framework. Then, one or more rigid bars like bar 26 are attached to the back side 13, so as to maintain the desired decorative shape. Accordingly, the use of non-knotted pliable materials, such as knitted materials, is also feasible. Bar 26 may be attached to a knitted matrix as easily as to a knotted macramé matrix, and will serve the same function of maintaining a desired decorative shape.

Framework members like bar 26 may be attached by removable hooks 28 or other suitable fasteners, sewn, adhered, or otherwise attached to the back side of matrix 12. In addition, or in the alternative, such parts of the framework as are decorative may be attached to front side 11. In the exemplary embodiment, a single horizontal bar 26 at the base of the triangle shape may suffice for maintaining the desired tree-like shape. In the alternative, additional horizontal bars may be added at higher levels in the triangle. The wall hanging 10 with one or more horizontal bars may thus be easily folded or rolled up for storage or shipping. Bar 26 may comprise an inexpensive plastic or wood material, or any other desired rigid material.

Having thus described a preferred embodiment of the decorative wall hanging, it should be apparent to those skilled in the art that certain advantages of the within system have been achieved. It should also be appreciated that various modifications, adaptations, and alternative embodiments thereof may be made within the scope and spirit of the present invention. For example, a wall hanging in the shape of a Christmas tree has been illustrated, but it should be apparent that the inventive concepts described above would be equally applicable to other shapes, such as, for example, a menorah, star, angel, sleigh, or the like. The invention is defined by the following claims.

What is claimed is:

1. A wall hanging, comprising:
a substantially flat pliable matrix comprised of intertwined cords defining a pattern of regularly spaced openings defined by interstices between adjacent ones of the cords, the matrix having a front side and a back side and defining an outline of a decorative shape; and
a plurality of miniature lights interconnected by a wire, each of the miniature lights inserted through one of the openings so as to be visible from the front side of the matrix with the wire running along the back side of the matrix.

2. The wall hanging of claim 1, further comprising a rigid bar attached to the back side of the matrix.

3. The wall hanging of claim 2, further comprising a plurality of removable hooks attaching the rigid bar to the matrix.

4. The wall hanging of claim 2, wherein the rigid bar is substantially horizontal.

5. The wall hanging of claim 1, wherein the decorative shape comprises an isosceles triangle configured for hanging from an apex thereof.

6. The wall hanging of claim 4, further comprising a fringe of loose cords along a lower edge of the decorative shape.

7. The wall hanging of claim 4, further comprising a bundle of cords extending from a central region of a lower edge of the decorative shape.

8. The wall hanging of claim 4, further comprising a ring attached to the apex of the isosceles triangle.

9. The wall hanging of claim 1, wherein the flat pliable matrix comprises a macramé matrix.

10. The wall hanging of claim 1, wherein the flat pliable matrix comprises a knitted matrix.

11. The wall hanging of claim 1, wherein the decorative shape resembles a Christmas tree.

12. A wall hanging, comprising:
a substantially flat pliable matrix comprised of intertwined cords defining a pattern of regularly spaced openings defined interstices of adjacent ones of the cords, the matrix having a front side and a back side and defining an outline of a decorative shape; and
a rigid bar removably attached to the back side of the matrix.

13. The wall hanging of claim 12, further comprising a plurality of removable hooks attaching the rigid bar to the matrix.

14. The wall hanging of claim 12, wherein the rigid bar is substantially horizontal.

15. The wall hanging of claim 12, wherein the decorative shape comprises an isosceles triangle configured for hanging from an apex thereof.

16. The wall hanging of claim 15, further comprising a fringe of loose cords along a lower edge of the decorative shape.

17. The wall hanging of claim 15, further comprising a bundle of cords extending from a central region of a lower edge of the decorative shape.

18. The wall hanging of claim 15, further comprising a ring attached to the apex of the isosceles triangle.

19. The wall hanging of claim 15, wherein the flat pliable matrix comprises a macramé matrix.

20. The wall hanging of claim 15, wherein the flat pliable matrix comprises a knitted matrix.
